(19) United States
(12) Patent Application Publication
(10) Pub. No.: US 2023/0412272 A1
(43) Pub. Date: Dec. 21, 2023

(54) MIGRATION ASSIST DEVICE, MIGRATION METHOD AND OPTICAL ACCESS SYSTEM

(71) Applicant: NIPPON TELEGRAPH AND TELEPHONE CORPORATION, Tokyo (JP)

(72) Inventors: Satoshi SHIMAZU, Musashino-shi, Tokyo (JP); Tomoaki YOSHIDA, Musashino-shi, Tokyo (JP); Takayoshi TASHIRO, Musashino-shi, Tokyo (JP); Kenta ITO, Musashino-shi, Tokyo (JP)

(73) Assignees: NIPPON TELEGRAPH AND TELEPHONE CORPORATION, Tokyo (JP); NIPPON TELEGRAPH AND TELEPHONE CORPORATION, Tokyo (JP)

(21) Appl. No.: 18/035,223

(22) PCT Filed: Nov. 10, 2020
(86) PCT No.: PCT/JP2020/041901

§ 371 Date: May 3, 2023

(51) Int. Cl. H04B 10/27

(52) U.S. Cl. CPC H04B 10/27

(57) ABSTRACT

A transition assistance device that assists device replacement in an optical access system including a transition source subscriber line terminal station device and a transition destination subscriber line terminal station device, the transition assistance device including: a first member, and a second member that is movable, in which the first member includes a first port for connecting to the transition source subscriber line terminal station device, and a second port for connecting to the transition destination subscriber line terminal station device, the second member includes a third port for connecting to one or more subscriber line terminal devices connected to the transition source subscriber line terminal station device, and at a start of the device replacement, the first port and the third port are connected to each other via a connection line; a cutting unit that cuts the connection line connecting the first port and the third port to each other after the transition assistance device is connected to the transition destination subscriber line terminal station device via the second port; a movement control unit that moves the second member after the connection line is cut; and a connection unit that connects the second port and the third port to each other with connection lines after movement of the second member.

### TECHNICAL FIELD

The present invention relates to a transition assistance device, a transition method, and an optical access system.

### BACKGROUND ART

FIG. 12 is a diagram illustrating a configuration of an optical access system 1000 in a conventional technology. The optical access system 1000 illustrated in FIG. 12 includes three optical network units (ONUs) 100-1 to 100-3, three optical line terminals (OLTs) 200-1 to 200-3, and two relay devices 300-1 to 300-2. User terminals 400-1 to 400-3 are connected to the ONUs 100-1 to 100-3, respectively. Note that the numbers of the ONUs 100, the OLTs 200, the relay devices 300, and the user terminals 400 are examples.

An OLT 200 is connected to an ONU 100 via an optical fiber, aggregates user data transmitted from respective user terminals 400, and transfers the user data to a relay device 300 belonging to a network to which the user terminals 400 belong. The OLT 200 distributes the data transmitted from the relay device 300 belonging to the network to which the user terminals 400 belong to the ONUs 100 to which the user terminals 400 as destinations are connected. In a case where the OLT 200 is physically connected to the ONUs 100 by a single star (SS) method, the OLT 200 is connected on a one-to-one basis. The OLT 200 includes a plurality of ports connected on a one-to-N basis (N is an integer greater than or equal to 1) in the case of a passive optical network (PON), and includes a plurality of ports connected to a plurality of the relay devices 300. For example, as illustrated in FIG. 12, the OLT 200 includes a plurality of ports 202-1 to 202-3 for connecting to the plurality of ONUs 100, and a plurality of ports 203-1 to 203-2 for connecting to the plurality of relay devices 300.

The OLT 200 includes a transfer table in which transfer destinations of the user data transmitted from the user terminals 400 are registered, and transfers the user data transmitted from the user terminals 400 from the ports to ports of the transfer destinations in accordance with the transfer table.

Even if a failure does not occur, the OLT 200 needs to be replaced in a planned manner for aged deterioration or provision of a new function. Hereinafter, replacement of an OLT 20 with a new OLT 200 for aged deterioration or provision of a new function will be described as transition. In the transition of the OLT 200, a setting inside the OLT 200 including a setting of the transfer table can be changed by command input or the like. On the other hand, in connection switching of the optical fiber from the OLT 200 as a transition source to the OLT 200 as a transition destination, it takes time to change a physical port to which a cable is connected.

It is desirable that communication interruption of the user terminals 400 caused by cable connection change work is as short as possible. If the entire work is prolonged, it is difficult to secure work operation. The transition is completed only after all steps are ended. If connection work, setting change work, and the like occur many times during that time, an entire work period increases, and operation of controlling the entire work is also required while securing the work operation during that time.

A conventional transition procedure will be described with reference to FIGS. 13 to 15. As illustrated in FIG. 13, a description will be given assuming that the OLT 200-2 is a transition source OLT, and the OLT 200-3 is a transition destination OLT. As illustrated in FIG. 13, the transition source OLT 200-2 includes the plurality of ports 202-1 to 202-3 for connecting to the ONUs 100 and a port 203 for connecting to the relay device 300. Similarly, the transition destination OLT 200-3 includes a plurality of ports 205-1 to 205-3 for connecting to the ONUs 100 and a port 204 for connecting to the relay device 300. A description will be given assuming that connection relationship is switched from the transition source OLT 200-2 to the transition destination OLT 200-3, as indicated by dotted lines in FIG. 13, in the transition of the OLT 200.

### (Step 1)

First, an operator newly installs the transition destination OLT 200-3 (FIG. 14(A)).

### (Step 2)

Next, the operator performs setting of the transfer table by copying or converting the transfer table to be used in the transition destination OLT 200-3 from the transition source OLT 200-2. As a result, the connection relationship between the ports of the transition destination OLT 200-3 is set similarly to that of the transition source OLT 200-2 (FIG. 14(B)). During a period from step 1 to step 2, the transition source OLT 200-2 can communicate with both the ONUs 100 and the relay device 300.

### (Step 3)

Next, the operator removes a connection line 450 (optical fiber) connecting the relay device 300 and the transition source OLT 200-2 together from the transition source OLT 200-2, and reattaches the removed connection line 450 to the port 204 of the transition destination OLT 200-3 (FIG. 14(C)). As a result, communication interruption occurs in each of the user terminals 400-1 to 400-3.

### (Step 4)

Next, the operator removes a connection line 460 (optical fiber) connecting the transition source OLT 200-2 and the ONU 100-1 together from the transition source OLT 200-2, and reattaches the removed connection line 460 to the port 205-1 of the transition destination OLT 200-3. Communication restoration of the ONU 100-1 is confirmed in the transition destination OLT 200-3. The communication restoration of the ONU 100-1 is confirmed, whereby communication between the user terminal 400-1 and the relay device 300 becomes possible (FIG. 14(D)).

### (Step 5)

Next, the operator removes a connection line 470 (optical fiber) connecting the transition source OLT 200-2 and the ONU 100-2 together from the transition source OLT 200-2, and reattaches the removed connection line 470 to the port 205-2 of the transition destination OLT 200-3. Communication restoration of the ONU 100-2 is confirmed in the transition destination OLT 200-3. The communication restoration of the ONU 100-2 is confirmed, whereby communication between the user terminal 400-2 and the relay device 300 becomes possible (FIG. 15(A)).

### (Step 6)

Next, the operator removes a connection line 480 (optical fiber) connecting the transition source OLT 200-2 and the ONU 100-3 together from the transition source OLT 200-2, and reattaches the removed connection line 480 to the port 205-3 of the transition destination OLT 200-3. Communication restoration of the ONU 100-3 is confirmed in the transition destination OLT 200-3. The communication restoration of the ONU 100-3 is confirmed, whereby communication between the user terminal 400-3 and the relay device 300 becomes possible (FIG. 15(B)).

In the above example, three ONUS 100 have been described as an example; however, in a case where four or more ONUs 100 are connected to the transition source OLT 200-2, processing similar to that in step 4 is executed as many as the number of ONUs 100.

### (Step 7)

After the connection switching of all the ONUs 100 connected to the transition source OLT 200-2 is completed, the operator removes the transition source OLT 200-2 (FIG. 15(C)). As a result, transition processing is completed.

### CITATION LIST

### Patent Literature

Patent Literature 1: JP 2011-71951 A

### Non Patent Literature

Non Patent Literature 1: Mitsui et al., “N:M PON Protection Architecture for 10 Gbit/s Class PON Systems, The IEICE Transactions B, Vol. J96-B, No. 3, pp. 283-291

### SUMMARY OF INVENTION

### Technical Problem

As described above, in a case where the connection line to the relay device 300 is switched to the transition destination OLT 200-3 first, the user terminal 400 connected to the ONU 100 for which the connection line has been switched first can recover early. On the other hand, the user terminal 400 connected to the ONU 100 whose switching order is late continues to be disconnected until the switching is completed, so that communication interruption time increases.

In a case where the connection line to the ONU 100 is switched to the transition destination OLT 200-3 first (step 3 and steps 4 to 6 are replaced with each other), the connection line connected to each ONU 100 is first switched from the transition source OLT 200-2 to the transition destination OLT 200-3. In a state where only the connection line is switched, it is a state where the communication is disconnected, and the communication cannot be resumed unless the switching of the connection line to the relay device 300 is also completed, and it takes time for the communication restoration.

As described above, in the conventional transition method, the switching of a connection between a higher-level device (for example, the relay device 300) and a lower-level device (for example, the ONU 100) and setting change of the OLT 200 are completed, and the transition is completed. Thus, in the transition of the OLT 200, it takes time to complete not only switching work but also entire work. For that reason, there has been a problem that an influence of user's communication interruption is large.

In view of the above circumstances, an object of the present invention is to provide a technology capable of suppressing the influence of communication interruption in transition of a device.

### Solution to Problem

An aspect of the present invention is a transition assistance device that assists device replacement in an optical access system including: a transition source subscriber line terminal station device before device replacement, the transition source subscriber line terminal station device communicating with a higher-level device and one or more subscriber line terminal devices; and a transition destination subscriber line terminal station device that is a device replacement destination, the transition assistance device including: a first member, and a second member that is movable, in which the first member includes a first port for connecting to the transition source subscriber line terminal station device, and a second port for connecting to the transition destination subscriber line terminal station device, the second member includes a third port for connecting to the one or more subscriber line terminal devices connected to the transition source subscriber line terminal station device, and at a start of the device replacement, the transition assistance device is not connected to the transition destination subscriber line terminal station device via the second port, and the first port and the third port are connected to each other via a connection line; a cutting unit that cuts the connection line connecting the first port and the third port to each other after the transition assistance device is connected to the transition destination subscriber line terminal station device via the second port; a movement control unit that moves the second member after the connection line is cut by the cutting unit; and a connection unit that connects the second port and the third port to each other with connection lines after movement of the second member.

An aspect of the present invention is a transition method performed by a transition assistance device that assists device replacement in an optical access system including: a transition source subscriber line terminal station device before device replacement, the transition source subscriber line terminal station device communicating with a higher-level device and one or more subscriber line terminal devices; and a transition destination subscriber line terminal station device that is a device replacement destination, in which: the transition assistance device includes a first member, and a second member that is movable; the first member includes a first port for connecting to the transition source subscriber line terminal station device, and a second port for connecting to the transition destination subscriber line terminal station device; the second member includes a third port for connecting to the one or more subscriber line terminal devices connected to the transition source subscriber line terminal station device; and at a start of the device replacement, the transition assistance device is not connected to the transition destination subscriber line terminal station device via the second port, and the first port and the third port are connected to each other via a connection line, the transition method including: cutting the connection line connecting the first port and the third port to each other after the transition assistance device is connected to the transition destination subscriber line terminal station device via the second port; moving the second member after the connection line is cut; and connecting the second port and the third port to each other with connection lines after movement of the second member.

An aspect of the present invention is an optical access system including: a transition source subscriber line terminal station device before device replacement, the transition source subscriber line terminal station device communicating with a higher-level device and one or more subscriber line terminal devices; and a transition destination subscriber line terminal station device that is a device replacement destination, the optical access system including a transition assistance device that assists device replacement between the transition destination subscriber line terminal station device and the one or more subscriber line terminal devices, in which the transition assistance device includes: a first member, and a second member that is movable, in which the first member includes a first port for connecting to the transition source subscriber line terminal station device, and a second port for connecting to the transition destination subscriber line terminal station device, the second member includes a third port for connecting to the one or more subscriber line terminal devices connected to the transition source subscriber line terminal station device, and at a start of the device replacement, the transition assistance device is not connected to the transition destination subscriber line terminal station device via the second port, and the first port and the third port are connected to each other via a connection line; a cutting unit that cuts the connection line connecting the first port and the third port to each other after the transition assistance device is connected to the transition destination subscriber line terminal station device via the second port; a movement control unit that moves the second member after the connection line is cut by the cutting unit; and a connection unit that connects the second port and the third port to each other with connection lines after movement of the second member, and the transition destination subscriber line terminal station device includes: a higher-level device side transition unit including a higher-level port for connecting to the higher-level device and a first transition port that transfers data transferred from the higher-level device to the transition source subscriber line terminal station device; a transfer table setting unit that changes a setting of a transfer table in which a port at which data is received, a destination of the data, and a port of a transfer destination of the data are associated with each other; and a transfer control unit that performs data transfer to the transition source subscriber line terminal station device via at least the first transition port in accordance with the transfer table.

### Advantageous Effects of Invention

According to the present invention, it is possible to suppress the influence of communication interruption in transition of a device.

### BRIEF DESCRIPTION OF DRAWINGS

FIG. 1 is a diagram illustrating a configuration example of an optical access system 1 in the present invention.

FIG. 2 is a schematic diagram illustrating a specific configuration of a transition destination OLT 20.

FIG. 3 is a schematic diagram illustrating a specific configuration of a transition assistance device in the present embodiment.

FIG. 4 is a diagram for explaining the outline of the processing at the time of OLT transition in the optical access system.

FIG. 5 is a diagram for explaining the outline of the processing at the time of OLT transition in the optical access system.

FIG. 6 is a diagram for explaining an outline of processing at the time of OLT transition in the optical access system.

FIG. 7 is a sequence diagram for explaining a flow of processing at the time of transition in the optical access system.

FIG. 8 is a sequence diagram for explaining the flow of the processing at the time of transition in the optical access system.

FIG. 9 is a diagram for explaining a setting change of the transfer table at the time of transition in the optical access system.

FIG. 10 is a diagram for explaining a setting change of a transfer table at the time of transition in the optical access system.

FIG. 11 is a diagram for explaining a setting change of a transfer table at the time of transition in the optical access system.

FIG. 12 is a diagram illustrating a configuration of an optical access system in a conventional technology.

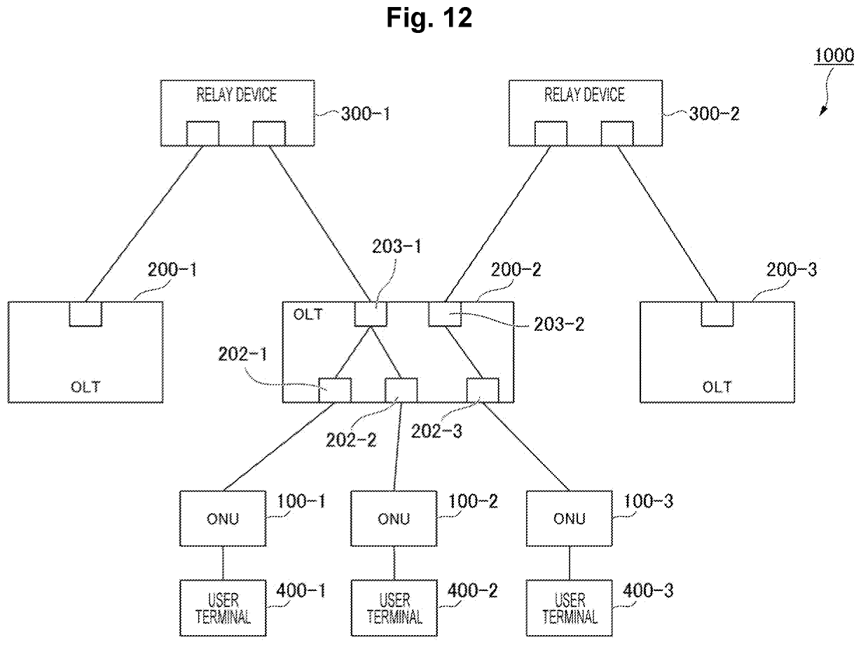

FIG. 13 is a schematic diagram for explaining the conventional transition procedure.

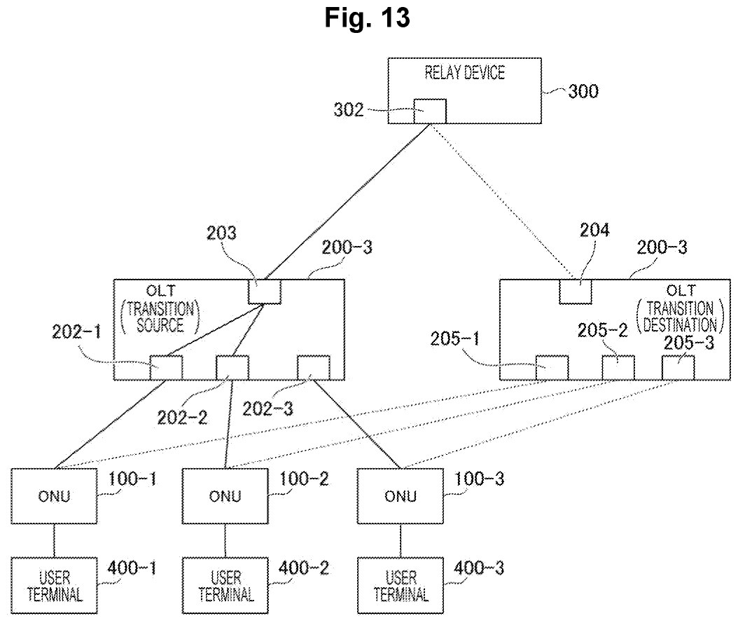

FIG. 14 is a schematic diagram for explaining the conventional transition procedure.

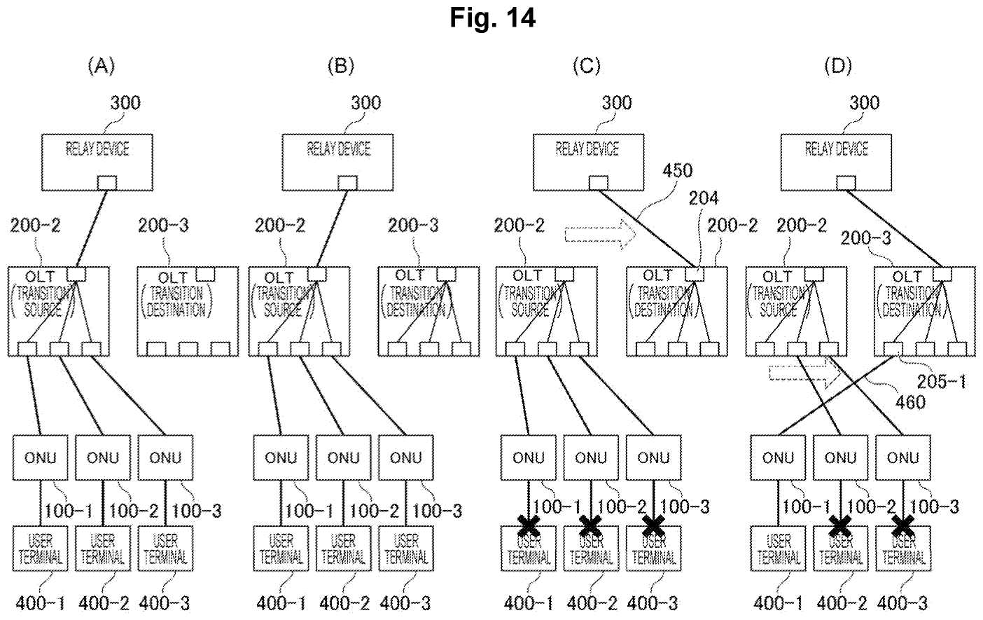

FIG. 15 is a schematic diagram for explaining the conventional transition procedure.

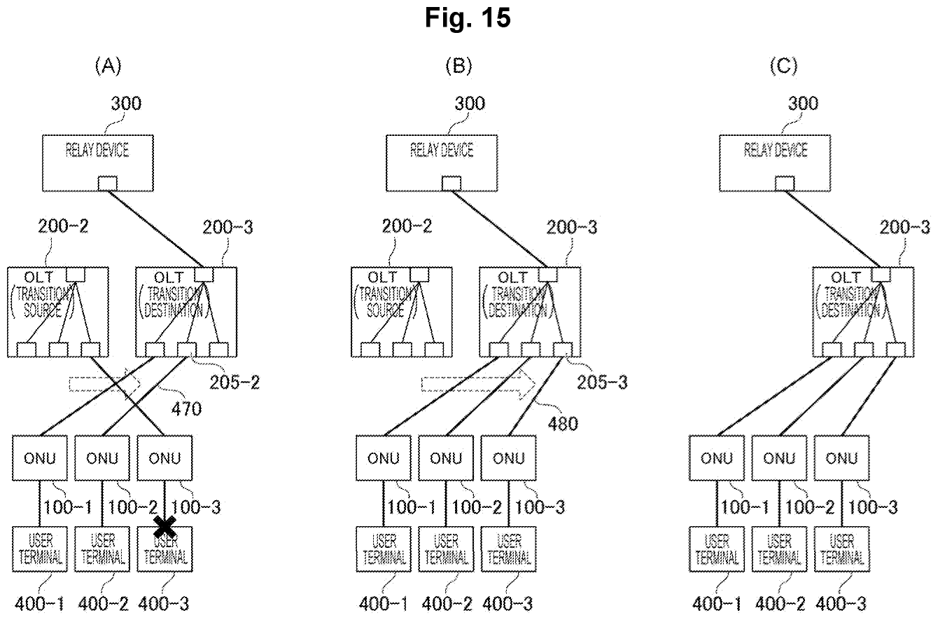

### DESCRIPTION OF EMBODIMENTS

Hereinafter, an embodiment of the present invention will be described with reference to the drawings.

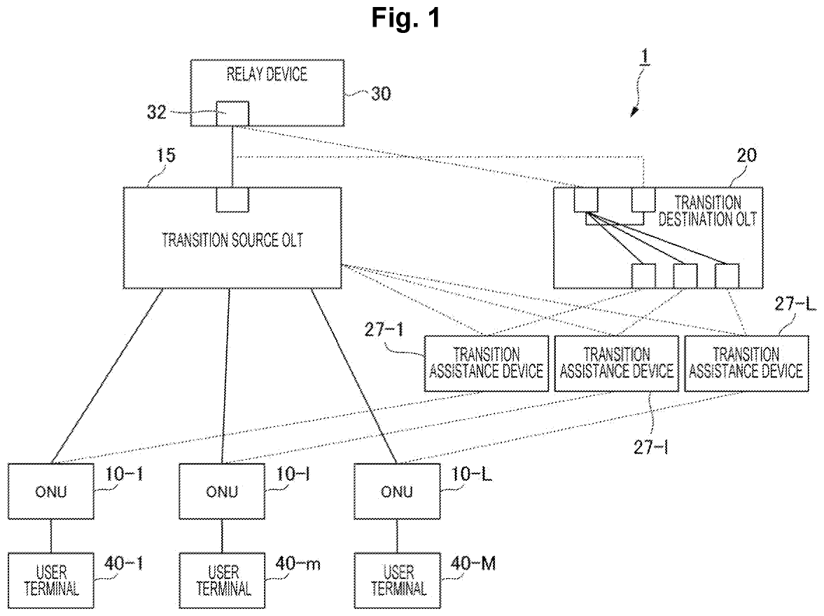

FIG. 1 is a diagram illustrating a configuration example of an optical access system 1 in the present invention.

The optical access system 1 includes one or more ONUs 10-1 to 10-L (L is an integer greater than or equal to 1), a transition source OLT 15 (transition source subscriber line terminal station device), a transition destination OLT 20 (transition destination subscriber line terminal station device), one or more transition assistance devices 27-1 to 27-L, and a relay device 30. The transition source OLT 15 and the ONUs 10-1 to 10-L are connected to each other via optical fibers. The transition source OLT 15 and the relay device 30 are connected to each other via an optical fiber. The numbers of the ONUs 10, the transition source OLTs 15, the transition destination OLTs 20, the transition assistance device 27, and the relay devices 30 included in the optical access system 1 are not particularly limited.

User terminals 40-1 to 400-M (M is an integer greater than or equal to 1) are connected to the ONUS 10-1 to 10-L, respectively. In FIG. 1, the user terminal 40-1 is connected to the ONU 10-1, the user terminal 40-m (m≤M) is connected to the ONU 10-1 (l≤L), and the user terminal 40-M is connected to the ONU 10-L. Further, the relay device 30 is connected to a higher level of the transition source OLT 15, and the ONUS 10-1 to 10-L are connected to a lower level of the transition source OLT 15. In the following description, the ONUS 10-1 to 10-L will be simply referred to as ONUS 10 unless otherwise distinguished.

An ONU 10 is installed, for example, in the home of a subscriber who receives provision of a communication service. The ONU 10 transmits user data transmitted from a user terminal 40 to a destination communication device via the transition source OLT 15 and the relay device 30. In a case where a connection destination is changed from the transition source OLT 15 to the transition destination OLT 20 due to transition, the ONU 10 transmits the user data transmitted from the user terminal 40 to the destination communication device via the transition assistance device 27, the transition destination OLT 20, and the relay device 30.

The transition source OLT 15 is an OLT that is replaced for aged deterioration or provision of a new function. The transition source OLT 15 includes a transfer table in which a destination, a reception port, and a transfer destination port are associated with each other, and transfers data in accordance with the transfer table. For example, before the transition, the transition source OLT 15 transfers data transmitted from the ONU 10, to other ONUs 10 or the relay device 30 in accordance with the transfer table, and transfers data transmitted from the relay device 30, to the ONU 10 in accordance with the transfer table. The transition source OLT 15 transmits and receives data via the transition destination OLT 20 during the transition. As a result, occurrence of communication interruption can be suppressed, and duration of communication can be lengthened.

The transition destination OLT 20 is an OLT to be a transition destination from the transition source OLT 15. The transition destination OLT 20 includes a relay device transfer port for transferring data transmitted from the relay device 30 (higher-level device) to return the data to the transition source OLT 15. As a result, the transition destination OLT 20 can continue communication of the user terminal 40 even during switching of other ONUs 10.

The transition assistance device 27 is a device that assists transition of an OLT and can switch connection of the ONU 10 from the transition source OLT 15 to the transition destination OLT 20. The transition assistance device 27 is provided, for example, between the ONU 10 and the transition source OLT 15 at the start of transition, and transfers data transmitted from the transition source OLT 15 to the ONU 10 or data transmitted from the ONU 10 to the transition source OLT 15. At the time of transition, the transition assistance device 27 cuts, for example, an optical fiber connected to the transition source OLT 15, and communicably connects the transition destination OLT 20 and the ONU 10 to each other. The transition assistance devices 27-1 to 27-L have the same configuration.

The relay device 30 is a device located at the higher level of the transition source OLT 15 and the transition destination OLT 20. The relay device 30 relays data transferred from the transition source OLT 15 and the transition destination OLT 20 to a relay device belonging to a destination network. The relay device 30 relays data relayed from another relay device to the transition source OLT 15 or the transition destination OLT 20.

The user terminal 40 is a communication terminal possessed by the subscriber. The user terminal 40 transmits data to the ONU 10 depending on operation. The user terminal 40 receives the data transmitted from the ONU 10. The user terminal 40 is configured using an information processing device.

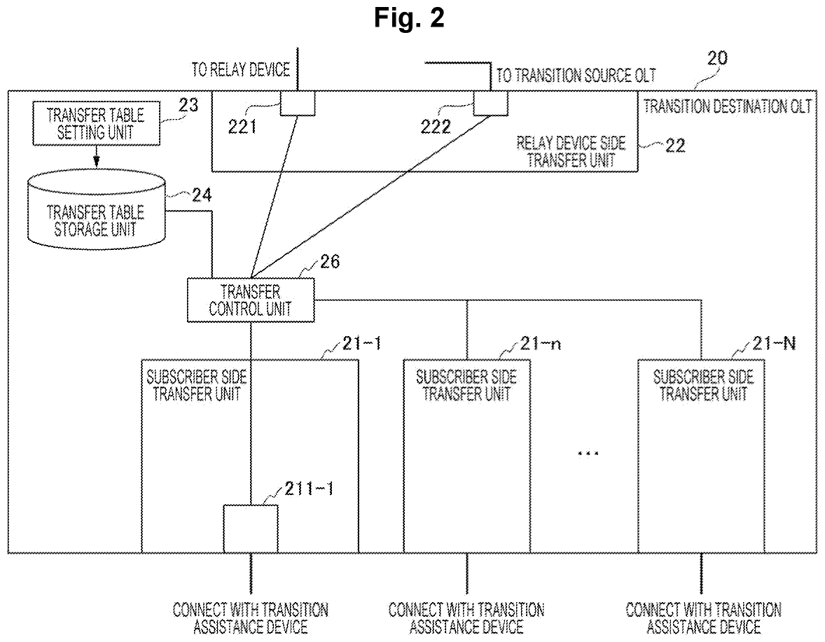

FIG. 2 is a schematic diagram illustrating a specific configuration of the transition destination OLT 20.

The transition destination OLT 20 includes one or more subscriber side transfer units 21-1 to 21-N, a relay device side transfer unit 22, a transfer table setting unit 23, a transfer table storage unit 24, and a transfer control unit 26.

The subscriber side transfer units 21-1 to 21-N transmit and receive data to and from the ONUS 10. At the time of transition, the subscriber side transfer units 21-1 to 21-N transmit and receive data to and from the ONUS 10 via the transition assistance devices 27-1 to 27-L. For example, one subscriber side transfer unit 21 transmits and receives data to and from one ONU 10. Note that, in a case where one subscriber side transfer unit 21 transmits and receives data to and from a plurality of ONUS 10, it is sufficient that a power splitter is provided between the subscriber side transfer unit 21 and the plurality of ONUS 10. The subscriber side transfer unit 21 includes an ONU connection port 211. In the following description, in a case where the ONU connection ports 211 included in the subscriber side transfer unit 21 are distinguished for each subscriber side transfer unit 21, they are distinguished by adding branch numbers.

The ONU connection port 211 is a port for communicating with the ONU 10. For example, an optical fiber for connecting to the transition assistance device 27 is attached to the ONU connection port 211.

The relay device side transfer unit 22 includes a plurality of ports 221 and 222. Although FIG. 2 illustrates a configuration in which the relay device side transfer unit 22 includes two ports, the relay device side transfer unit 22 may include three or more ports. One of the ports included in the relay device side transfer unit 22 is set as the relay device transfer port. Note that, which one of the ports 221 and 222 is set as the relay device transfer port is set by an input from the external device. In the following, a description will be given with the port 221 as the relay port 221, and the port 222 as the relay device transfer port 222.

The relay port 221 is a port connected to the relay device 30. For example, an optical fiber connected to the relay device 30 is attached to the port 221 during and after the transition.

The relay device transfer port 222 is a port connected to the transition source OLT 15. For example, an optical fiber for connecting to the transition source OLT 15 is attached to the relay device transfer port 222 during and after the transition. The relay device transfer port 222 can transfer data at a transfer rate greater than or equal to a transfer rate of the relay port 221.

The transfer table setting unit 23 performs setting of the transfer table to be used in the transition destination OLT 20. For example, at the start of transition, the transfer table setting unit 23 copies the transfer table held by the transition source OLT 15 to generate the transfer table depending on an instruction from the external device. Further, the transfer table setting unit 23 updates the transfer table depending on an instruction from the external device.

The transfer table is stored in the transfer table storage unit 24. The transfer table storage unit 24 is configured using a storage device such as a magnetic storage device or a semiconductor storage device.

The transfer control unit 26 transfers data between the subscriber side transfer unit 21 and the relay device side transfer unit 22 in accordance with the transfer table stored in the transfer table storage unit 24. For example, the transfer control unit 26 transfers data output from the subscriber side transfer unit 21 to the port 221 or the relay device transfer port 222. For example, the transfer control unit 26 transfers data output from the relay device transfer port 222 to the relay port 221.

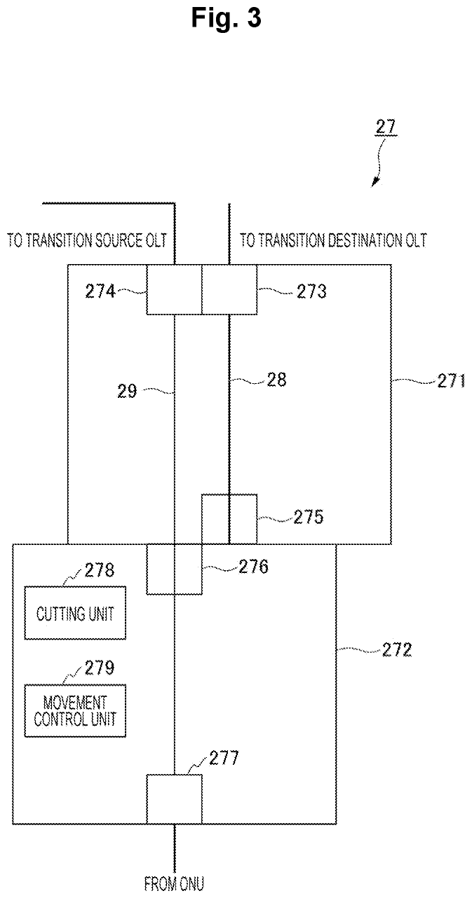

FIG. 3 is a schematic diagram illustrating a specific configuration of the transition assistance device 27.

The transition assistance device 27 includes a fixed member 271 (first member) and a movable member 272 (second member). In the transition assistance device 27, the movable member 272 is movable, and an optical fiber provided in the fixed member 271 for connecting to the transition destination OLT 20 and an optical fiber provided in the movable member 272 for connecting to the ONU 10 are connected together by fusion, whereby communication is enabled between the ONU 10 and the transition destination OLT 20.

More specifically, in the transition assistance device 27, when the movable member 272 moves and an outer side of the movable member 272 and an outer side of the fixed member 271 are aligned with each other, positions of fusion mechanisms included in the fixed member 271 and the movable member 272 substantially coincide with each other. The fusion mechanisms each are a fusion machine generally used for fusing optical fibers together.

The fixed member 271 includes a transition destination OLT connection port 273 (first port), a transition source OLT connection port 274 (second port), and a fusion mechanism 275 (connection unit).

The transition destination OLT connection port 273 is a port for communicating with the transition destination OLT 20. An optical fiber to be connected to the transition destination OLT 20 is attached to the transition destination OLT connection port 273.

The transition source OLT connection port 274 is a port for communicating with the transition source OLT 15. An optical fiber to be connected to the transition source OLT 15 is attached to the transition source OLT connection port 274.

The fusion mechanism 275 is a member having a function for fusing optical fibers together. An optical fiber 28 is installed between the fusion mechanism 275 and the transition destination OLT connection port 273. The fusion mechanism 275 connects the optical fiber provided in the movable member 272 and the optical fiber 28 together by fusion. In performing fusion, core positions of the optical fibers are aligned with each other by a core alignment technology of a fusion machine described in Reference Literature 1 below. As a result, a transition destination OLT connection port 273-1 and an ONU connection port 277-1 can be connected to each other by a connection line.

(Reference Document 1: “Core alignment fusion splicer 90S Faster. More accurately.”,

URL:https://e431.jp/upload/save_file/02171736_5e4a50 9e468db.pdf)

The movable member 272 is a member that is operated externally or manually. The movable member 272 includes a fusion mechanism 276 (connection unit), an ONU connection port 277, a cutting unit 278, and a movement control unit 279.

The fusion mechanism 276 is a member having a function for fusing optical fibers together. At the start of transition, the fusion mechanism 276 is located between the transition source OLT connection port 274 and the ONU connection port 277. An optical fiber 29 connecting the transition source OLT connection port 274 and the ONU connection port 277 to each other passes through the fusion mechanism 276. Then, at the time of transition, the fusion mechanism 276 connects the optical fiber provided in the fusion mechanism 275 and the optical fiber provided in the movable member 272 together by fusion.

The ONU connection port 277 is a port for communicating with the ONU 10. For example, an optical fiber for connecting to the ONU 10 is attached to the ONU connection port 277.

The cutting unit 278 cuts the optical fiber in accordance with an instruction from the outside. Specifically, the cutting unit 278 cuts the optical fiber protruding from the fusion mechanism 276 between the fixed member 271 and the movable member 272. The cutting unit 278 is, for example, an automatic fiber cutter.

The movement control unit 279 moves the movable member 272 in accordance with an instruction from the outside. Specifically, the movement control unit 279 moves the movable member 272 to a position where a position of the optical fiber in the fusion mechanism 276 coincides with a position of the optical fiber in the fusion mechanism 275. In a case where a distance to the position where the position of the optical fiber in the fusion mechanism 276 coincides with the position of the optical fiber in the fusion mechanism 275 is determined in advance, the movement control unit 279 may move the movable member 272 by the distance determined in advance.

Note that, since the transition assistance device 27 is configured by attaching other components included in the fixed member 271 and the movable member 272 to the fusion machines (the fusion mechanisms 275 and 276), it is possible to remove a functional unit that is detachable and is unnecessary after the transition is finished. That is, after the transition is completed, the components other than the fusion mechanisms 275 and 276 can be removed.

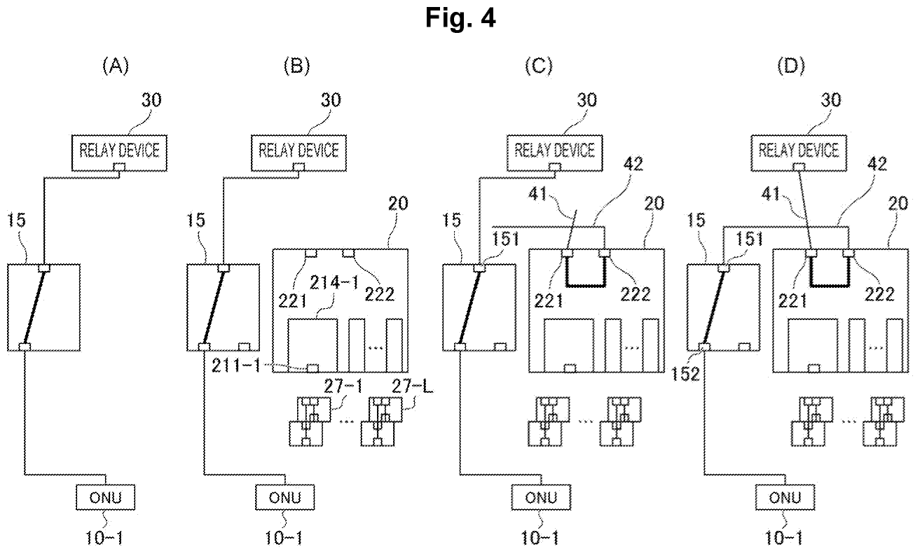

Next, with reference to FIGS. 4 to 6, a description will be given of an outline of processing at the time of OLT transition in the optical access system 1 of the present invention. FIGS. 4 to 6 are diagrams for explaining the outline of the processing at the time of OLT transition in the optical access system 1.

In a state before the start of transition, one or more ONUs 10 and the relay device 30 are in communication with each other via the transition source OLT 15 (FIG. 4(A)). Note that, in a case where description is not particularly necessary, description of other ONUs 10 is omitted in FIGS. 4 to 6. In FIG. 4(A), the ONU 10-1 is focused.

When starting the transition of the OLT, the operator installs the transition destination OLT 20 and the transition assistance device 27 (FIG. 4(B)). The number of the transition assistance devices 27 to be installed may be equal to the number of the transition destination OLTs 20.

Next, the operator performs setting of the transfer table of the transition destination OLT 20 and wiring on the relay device 30 side of the transition destination OLT 20 (FIG. 4(C)). At this time point, as the setting of the transfer table, the operator performs setting so that data output from the relay port 221 is transferred to the relay device transfer port 222, and the data output from the relay device transfer port 222 is transferred to the relay port 221. Further, as illustrated in FIG. 4(C), the operator attaches an optical fiber 41 to the relay port 221 of the transition destination OLT 20 and attaches an optical fiber 42 to the relay device transfer port 222.

Next, the operator performs connection of the wiring on the relay device 30 side of the transition destination OLT 20 (FIG. 4(D)). Specifically, first, the operator removes the optical fiber connecting the relay device 30 and the transition source OLT 15 to each other. With this work, connection between the ONU 10-1 and the relay device 30 is disconnected, whereby communication interruption occurs in the ONU 10-1. The operator attaches the optical fiber 41 connected to the relay port 221 of the transition destination OLT 20 to a port of the relay device 30, and attaches the optical fiber 42 connected to the relay device transfer port 222 of the transition destination OLT 20 to a port 151 of the transition source OLT 15.

As a result, as illustrated in FIG. 4(D), data transfer can be performed in the order of the relay device 30⇒the relay port 221 of the transition destination OLT 20⇒the relay device transfer port 222 the port 151 of the transition source OLT 15⇒a port 152 of the transition source OLT 15⇒the ONU 10-1. In data transfer from the ONU 10-1, the data transfer can be performed in a reverse order of the above. Communication restoration of the ONU 10-1 is confirmed in the transition destination OLT 20. The communication restoration of the ONU 10-1 is confirmed, whereby communication between the ONU 10-1 and the relay device 30 becomes possible.

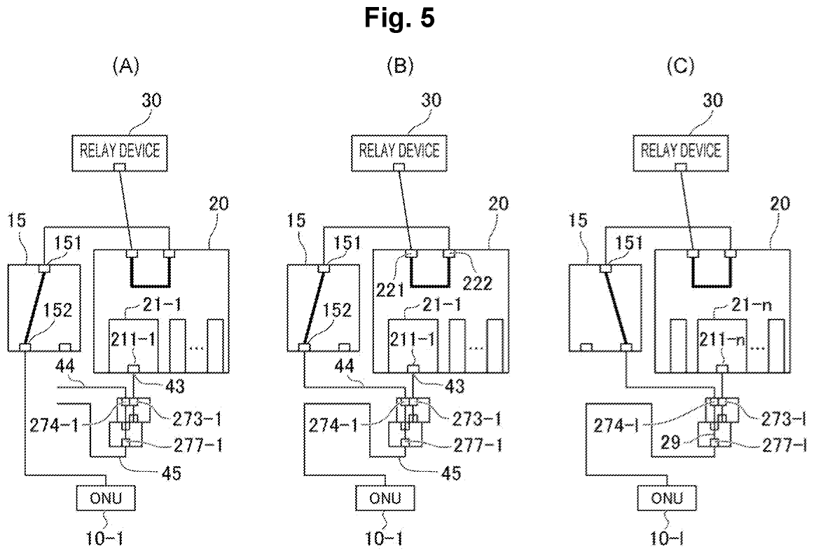

Next, the operator performs wiring on the ONU 10-1 side of the transition destination OLT 20 and wiring of the transition assistance device 27 (FIG. 5(A)). Specifically, as illustrated in FIG. 5(A), the operator attaches an optical fiber 43 to an ONU connection port 211-1 of the transition destination OLT 20, attaches an optical fiber 44 to a transition source OLT connection port 274-1 of the transition assistance device 27-1, and attaches an optical fiber 45 to the ONU connection port 277-1 of the transition assistance device 27-1.

Next, the operator performs connection of the wiring on the ONU 10-1 side of the transition destination OLT 20 and the wiring of the transition assistance device 27 (FIG. (5B)). Specifically, first, the operator removes the optical fiber connecting the ONU 10-1 and the transition source OLT 15 to each other. With this work, connection between the ONU 10-1 and the relay device 30 is disconnected, whereby communication interruption occurs in the ONU 10-1.

The operator attaches the optical fiber 43 connected to the ONU connection port 211-1 of the transition destination OLT 20 to the transition destination OLT connection port 273-1 of the transition assistance device 27-1. Further, the operator attaches the optical fiber 44 connected to the transition source OLT connection port 274-1 of the transition assistance device 27-1 to the port 152 of the transition source OLT 15. Further, the operator connects the optical fiber 45 connected to the ONU connection port 277-1 of the transition assistance device 27-1 and the optical fiber connected to the ONU 10-1 together. For example, the operator connects the optical fiber 45 and the optical fiber connected to the ONU 10-1 together by fusion.

As a result, as illustrated in FIG. 5(B), data transfer can be performed in the order of the ONU 10-1⇒the transition assistance device 27-1⇒the port 152 of the transition source OLT 15⇒the port 151 of the transition source OLT 15⇒the relay device transfer port 222 of the transition destination OLT 20⇒the relay port 221 of the transition destination OLT 20⇒the relay device 30. In data transfer from the relay device 30, the data transfer can be performed in a reverse order of the above. Communication restoration of the ONU 10-1 is confirmed in the transition destination OLT 20. The communication restoration of the ONU 10-1 is confirmed, whereby communication between the ONU 10-1 and the relay device 30 becomes possible.

The operator performs the work illustrated in FIGS. 5(A) and 5(B) for the ONUS 10 connected to the transition source OLT 15 (FIG. 5(C)). FIG. 5(C) illustrates an example in which the work illustrated in FIGS. 5(A) and 5(B) is executed for the ONU 10-1 connected to the transition source OLT 15.

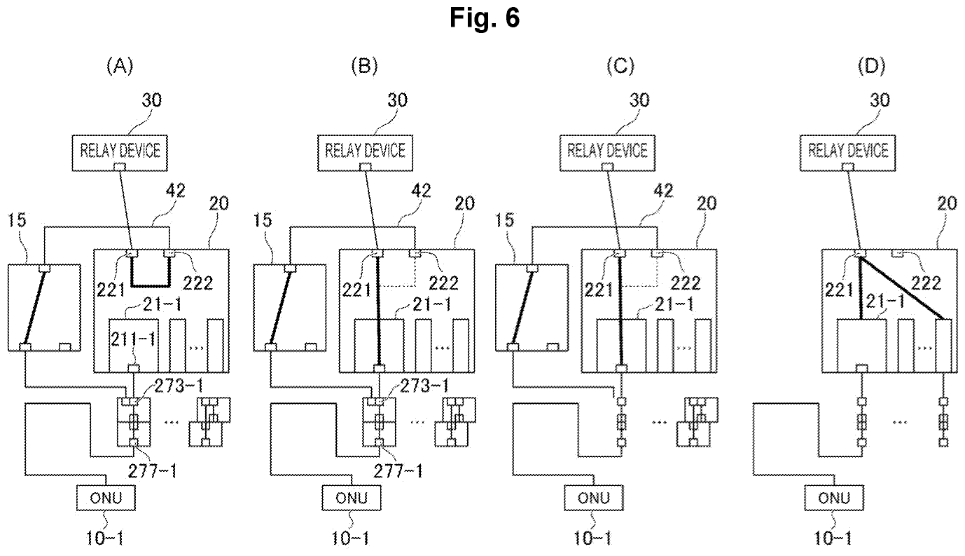

The transition assistance device 27-1 cuts the optical fiber 29 connecting the ONU 10-1 and the transition source OLT 15 to each other in accordance with an instruction from the outside, and moves a movable member 272-1 (FIG. 6(A)). Specifically, first, the transition assistance device 27-1 cuts the optical fiber 29 connecting the ONU 10-1 and the transition source OLT 15 to each other by a cutting unit 278-1. Next, the transition assistance device 27-1 moves the fusion mechanism 276 of the movable member 272-1 to a position of the fusion mechanism 275 of a fixed member 271-1. Then, the transition assistance device 27-1 fuses optical fibers together by the fusion mechanism 275 and the fusion mechanism 276. As a result, the ONU 10-1 and the transition destination OLT 20 are communicably connected to each other via the transition assistance device 27.

The operator performs setting of the transfer table of the transition destination OLT 20 (FIG. 6(B)). Specifically, as the setting of the transfer table, the operator performs setting so that data output from the subscriber side transfer unit 21-1 is transferred to the relay port 221 and data output from the relay port 221 is transferred to the subscriber side transfer unit 21-1. Note that, since the setting for the ONU 10-1 is performed at the present time, the operator does not change the setting of the transfer table corresponding to the ONU 10 other than the ONU 10-1.

As a result, as illustrated in FIG. 6(B), transfer can be performed to the relay device 30⇒the relay port 221 of the transition destination OLT 20⇒the subscriber side transfer unit 21-1 of the transition destination OLT 20⇒the transition assistance device 27-1⇒the ONU 10-1. Communication restoration of the ONU 10-1 is confirmed in the transition destination OLT 20. The communication restoration of the ONU 10-1 is confirmed, whereby communication between the ONU 10-1 and the relay device 30 becomes possible.

The operator removes components other than a core line after switching, in the transition assistance device 27-1 (FIG. 6(C)). For example, as illustrated in FIG. 6(C), the operator removes components other than members necessary for connecting the transition destination OLT 20 and the ONU 10 to each other. Thereafter, the operator performs the work illustrated in FIGS. 6(A) to 6(C) for the ONUs 10 connected to the transition assistance device 27.

Thereafter, the operator removes the transition source OLT 15 and extra wiring (for example, an optical fiber).

As a result, the transition of the OLT is completed.

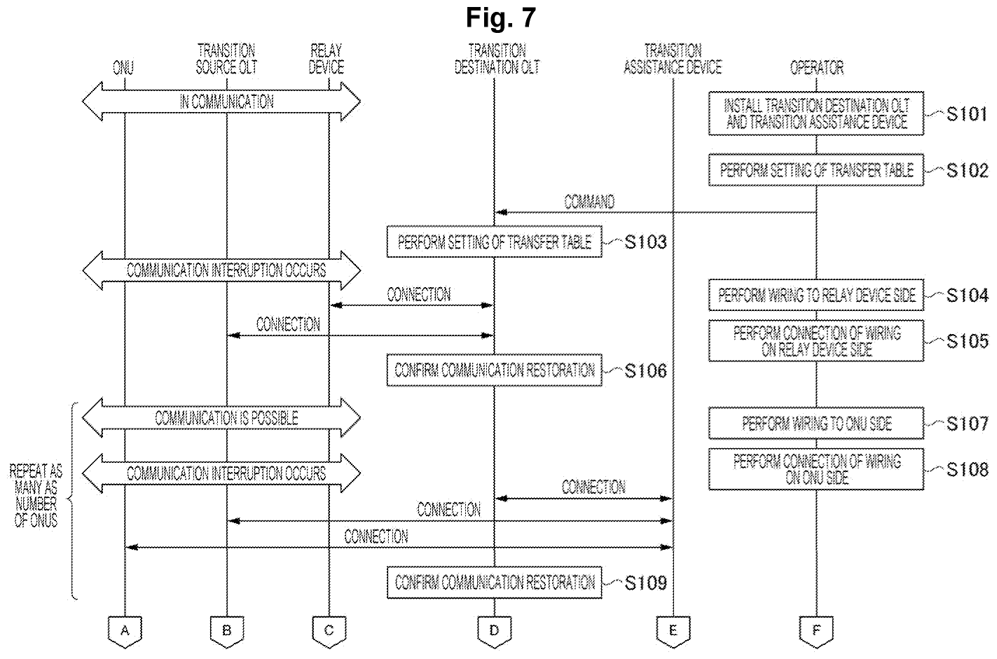

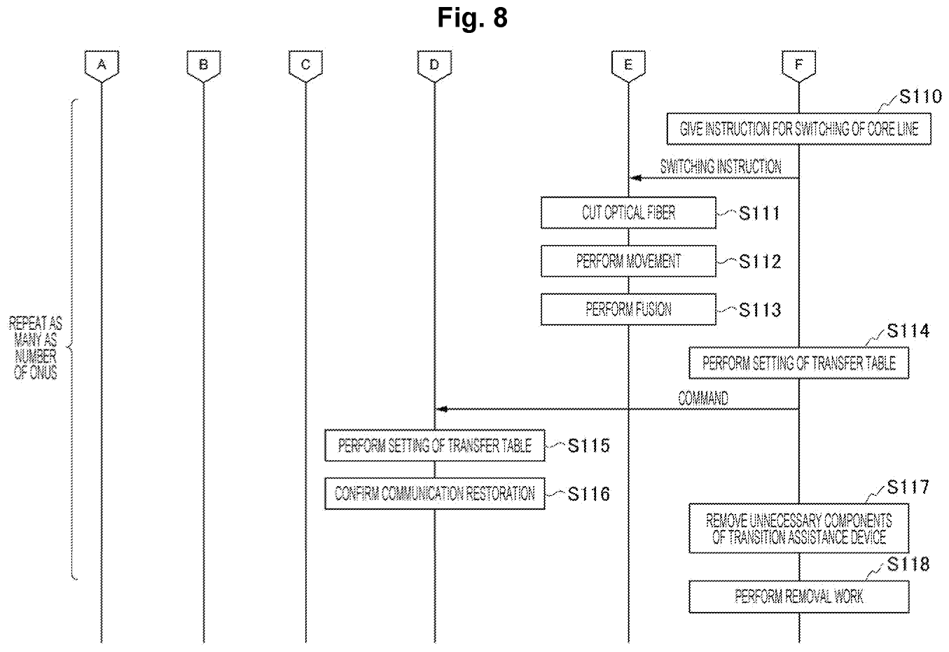

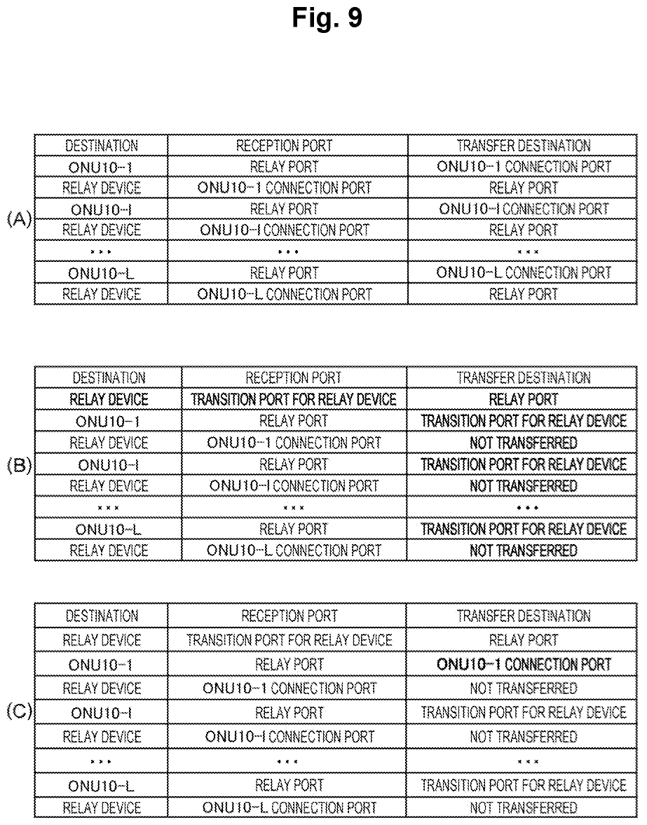

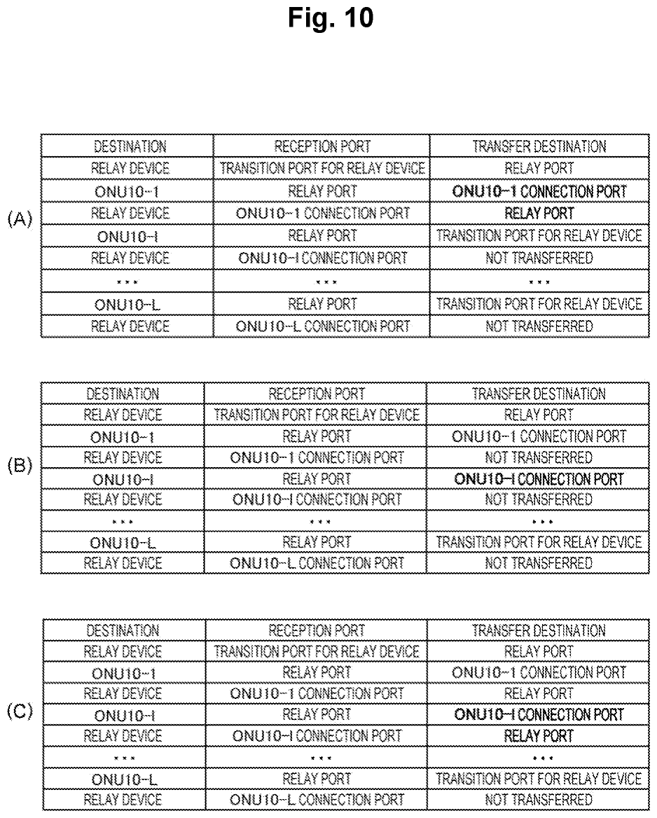

In FIGS. 4 to 6, the outline of the processing at the time of OLT transition has been described. Thus, next, with reference to FIGS. 7 to 10, a specific description will be given of an example of setting change of the transfer table and processing of each of functional units of the transition destination OLT 20. FIGS. 7 and 8 are sequence diagrams illustrating a flow of the processing at the time of OLT transition in the optical access system 1. It is a diagram for explaining setting changes of the transfer tables illustrated in FIGS. 9 to 10.

At the start of the processing of FIGS. 7 and 8, it is assumed that the ONU 10 and the relay device 30 are in communication with each other via the transition source OLT 15. It is assumed that the setting of the transfer table included in the transition source OLT 15 is as in FIG. 9(A). In the transfer table illustrated in FIG. 9(A), the setting is made so that in a case where data whose destination is the ONU 10-1 is received at a port (relay port) connected to the relay device 30, the received data is transferred to a port (ONU 10-1 connection port) to which the ONU 10-1 is connected. In the transfer table illustrated in FIG. 9(A), the setting is made so that in a case where data whose destination is the relay device 30 is received at the ONU 10-1 connection port, the received data is transferred to the relay port.

It is assumed that the transition of the OLT is started in such a state. First, the operator installs the transition destination OLT 20 and the transition assistance device 27 (step S101). As a result, the transition destination OLT 20 and the transition assistance device 27 are installed near the transition source OLT 15. Next, the operator operates the external device to perform setting of the transfer table of the transition destination OLT 20 (step S102). For example, the operator performs setting of the transfer table of the transition destination OLT 20 on the basis of the transfer table illustrated in FIG. 9(A). The external device transmits a setting change command to the transition destination OLT 20.

For example, the operator operates the external device to transmit, to the transition destination OLT 20, a command for causing contents 1 to 3 described below to be set in the transfer table.

(Content 1) A content for causing a destination “relay device 30”, a reception port “relay device transfer port 222”, and a transfer destination “relay port 221” to be set.

Content 1 is a content for causing settings to be set so that in a case where the data whose destination is the relay device 30 is received at the relay device transfer port 222 of the transition destination OLT 20, the received data is transferred to the relay port 221.

(Content 2) A content for causing a destination “ONU 10”, a reception port “relay port 221”, and a transfer destination “relay device transfer port 222” to be set.

Content 2 is a content for causing settings to be set so that in a case where the data whose destination is ONU 10 is received at the relay port 221, the received data is transferred to the relay device transfer port 222.

(Content 3) A content for causing a destination “relay device 30”, a reception port “ONU connection port 211”, and a transfer destination “not transferred” to be set.

Content 3 is a content for causing settings to be set so that in a case where the data whose destination is the relay device 30 is received at the ONU connection port 211, the received data is not transferred.

The transfer table setting unit 23 performs setting of the transfer table in accordance with the command transmitted from the external device (step S103). For example, the transfer table setting unit 23 performs setting by updating information of the transfer table illustrated in FIG. 9(A) as illustrated in FIG. 9(B). The transfer table setting unit 23 stores the updated transfer table in the transfer table storage unit 24.

Next, the operator performs wiring to the relay device 30 side of the transition destination OLT 20 (step S104). For example, the operator performs wiring to the relay port 221 and the relay device transfer port 222 on the relay device 30 side of the transition destination OLT 20. Since the specific processing of step S104 is described in FIG. 4(C), the description thereof is omitted.

The operator performs connection of the wiring on the relay device 30 side of the transition destination OLT 20 (step S105). For example, the operator performs connection of the wiring of the relay port 221 and the relay device transfer port 222 on the relay device 30 side of the transition destination OLT 20. Since the specific processing in step S105 is described in FIG. 4(D), the description thereof is omitted. Communication restoration of each ONU 10 is confirmed in the transition destination OLT 20 (step S106).

When the processing of step S106 is performed, data can be transmitted and received between the ONU 10 and the relay device 30 even during the transition. Specific examples will be described. First, downlink data transmission from the relay device 30 to the ONU 10 will be described. It is assumed that the data addressed to the ONU 10-1 is transferred from the relay device 30 to the transition destination OLT 20 after the processing of step S106. In this case, the transition destination OLT 20 receives, at the relay port 221, the data addressed to the ONU 10-1 transmitted from the relay device 30. On the basis of the received data and the relay port 221 receiving the data, the transfer control unit 26 refers to the transfer table stored in the transfer table storage unit 24 and determines the transfer destination of the data. In the transfer table illustrated in FIG. 9(B), in a case where the destination is the ONU 10-1 and the reception port is the relay port 221, the transfer destination is set to the relay device transfer port 222. Thus, the transfer control unit 26 transfers the received data to the relay device transfer port 222.

The relay device transfer port 222 is connected to the port 151 of the transition source OLT 15 via an optical fiber. For that reason, the data output from the relay device transfer port 222 is input to the port 151 of the transition source OLT 15. Since the ONU 10-1 is connected to the transition source OLT 15, the transition source OLT 15 transfers the received data to the ONU 10-1 that is a destination. As described above, the downlink data transmission from the relay device 30 to the ONU 10 becomes possible.

Next, uplink data transmission from the ONU 10 to the relay device 30 will be described. It is assumed that data addressed to the relay device 30 is transmitted from the ONU 10-1 to the transition source OLT 15. In this case, the transition source OLT 15 transfers the data transmitted from the ONU 10-1 to the relay device transfer port 222 of the transition destination OLT 20 via the port 151. The transition destination OLT 20 receives, at the relay device transfer port 222, the data addressed to the relay device 30 transferred from the transition source OLT 15. On the basis of the received data and the relay device transfer port 222 receiving the data, the transfer control unit 26 refers to the transfer table and determines the transfer destination of the data. In the transfer table illustrated in FIG. 9(B), in a case where the destination is the relay device 30 and the reception port is the relay device transfer port 222, the transfer destination is set to the relay port 221. Thus, the transfer control unit 26 transfers the received data to the relay port 221.

The relay port 221 is connected to the relay device 30 via an optical fiber. For that reason, the data output from the relay port 221 is input to the relay device 30. The relay device 30 transfers the received data to a relay device of a network to which a communication device as a destination belongs. As described above, the uplink data transmission from the ONU 10 to the relay device 30 becomes possible.

Next, the operator performs wiring to the ONU 10 side of the transition destination OLT 20 (step S107). For example, first, the operator performs wiring to the ONU connection port 211-1 and the transition source transfer port 213-1 of the subscriber side transfer unit 21-1 among the plurality of subscriber side transfer units 21 of the transition destination OLT 20. Since the specific processing in step S107 is described in FIG. 5(A), the description thereof is omitted.

The operator performs connection of the wiring on the ONU 10 side of the transition destination OLT 20 (step S108). Since the specific processing in step S108 is described in FIG. 5(B), the description thereof is omitted. Communication restoration of the ONU 10-1 is confirmed in the transition destination OLT 20 (step S109).

Even while wiring connection work to the ONU 10-1 is being performed, the other ONUS 10 are connected to the transition source OLT 15 via the transition assistance device 27, and can continue data transmission and reception with the relay device 30. In the ONU 10-1, when the processing of step S109 is performed, data can be transmitted and received between the ONU 10-1 and the relay device 30 even during the transition. Specific examples will be described. Downlink data transmission from the relay device 30 to the ONU 10-1 will be described. It is assumed that the data addressed to the ONU 10-1 is transferred from the relay device 30 to the transition destination OLT 20 after the processing of step S109. In this case, the transition destination OLT 20 receives, at the relay port 221, the data addressed to the ONU 10-1 transmitted from the relay device 30. On the basis of the received data and the relay port 221 receiving the data, the transfer control unit 26 refers to the transfer table stored in the transfer table storage unit 24 and determines the transfer destination of the data. In the transfer table illustrated in FIG. 9(B), in a case where the destination is the ONU 10-1 and the reception port is the relay port 221, the transfer destination is set to the relay device transfer port 222. Thus, the transfer control unit 26 transfers the received data to the relay device transfer port 222.

The relay device transfer port 222 is connected to the port 151 of the transition source OLT 15 via an optical fiber. For that reason, the data output from the relay device transfer port 222 is input to the port 151 of the transition source OLT 15. In the transition source OLT 15, the port 152 connected to the ONU 10-1 is connected to the transition source OLT connection port 274-1 of the transition assistance device 27-1 by the processing of step S108. For that reason, the data addressed to the ONU 10-1 output from the transition source OLT 15 is transferred to the transition source OLT connection port 274-1 of the transition assistance device 27-1 via the port 152.

The data input to the transition source OLT connection port 274-1 of the transition assistance device 27-1 is output from the ONU connection port 277-1. The ONU 10-1 is connected to the ONU connection port 277-1 by the processing of step S108. For that reason, the data output from the ONU connection port 277-1 is transferred to the ONU 10-1.

The uplink data transmission from the ONU 10-1 to the relay device 30 is not described because reverse processing of the downlink data transmission is performed.

The operator executes the processing from step S107 to step S109 as many as the number of ONUS 10 connected to the transition source OLT 15. As a result, all the ONUS 10 connected to the transition source OLT 15 are connected to the transition assistance devices 27 associated with the respective ONUS 10. Thereafter, the operator operates the external device to give an instruction for switching of a core line of the transition assistance device 27 (step S110). For example, the operator operates the external device to give an instruction for switching of the transition assistance device 27-1. The external device transmits a switching instruction to the transition assistance device 27-1. The switching instruction includes not only an instruction to cut the optical fiber but also an instruction to move the movable member 272 and to fuse the optical fibers together.

The cutting unit 278-1 of the transition assistance device 27-1 cuts the optical fiber on the basis of the switching instruction transmitted from the external device (step S111). As a result, connection between the ONU 10 and the transition source OLT 15 is disconnected, whereby communication interruption occurs in the ONU 10-1. Next, the movement control unit 279 moves the movable member 272 on the basis of the switching instruction transmitted from the external device (step S112). Specifically, the movement control unit 279 moves the movable member 272 to a position where the optical fiber included in the fusion mechanism 276 of the movable member 272 and the optical fiber included in the fusion mechanism 275 of the fixed member 271 can be fused together.

The fusion mechanism 275 and the fusion mechanism 276 fuse the optical fibers together after the movement by the movement control unit 279 is finished (step S113). As an optical fiber fusion method, an existing method is used. As a result, the ONU 10 and the transition destination OLT 20 can communicate with each other via the optical fiber. Note that, here, after the fusion, the operator confirms connection between the ONU 10 and the transition destination OLT 20.

If no particular problem is found in the connection between the ONU 10 and the transition destination OLT 20, the operator operates the external device to perform setting of the transfer table of the transition destination OLT 20 (step S114). For example, the operator performs setting of the transfer table of the transition destination OLT 20 on the basis of the transfer table illustrated in FIG. 9(B).

The operator first operates the external device to transmit, to the transition destination OLT 20, a command for causing Content 4 described below to be set in the transfer table.

(Content 4) A content for causing a destination “ONU 10-1”, a reception port “relay port 221”, and a transfer destination “ONU connection port 211-1” to be set.

Content 4 is a content for causing settings to be set so that in a case where the data whose destination is the destination ONU 10-1 is received at the relay port 221 of the transition destination OLT 20, the received data is transferred to the ONU connection port 211-1.

The transfer table setting unit 23 performs setting of the transfer table in accordance with the command transmitted from the external device (step S115). For example, the transfer table setting unit 23 performs setting by updating information of the transfer table illustrated in FIG. 9(B) as illustrated in FIG. 9(C). The transfer table setting unit 23 stores the updated transfer table in the transfer table storage unit 24.

The operator then operates the external device to transmit, to the transition destination OLT 20, a command for causing Content 5 described below to be set in the transfer table.

(Content 5) A content for causing a destination “relay device 30”, a reception port “ONU connection port 211-1”, and a transfer destination “relay port 221” to be set.

Content 5 is a content for causing settings to be set so that in a case where the data whose destination is the relay device 30 is received at the ONU connection port 211-1 of the transition destination OLT 20, the received data is transferred to the relay port 221. Note that, in Content 5, the branch number of the ONU connection port 211 changes depending on the ONU 10 that is a switching target.

The transfer table setting unit 23 performs setting of the transfer table in accordance with the command transmitted from the external device. For example, the transfer table setting unit 23 performs setting by updating information of the transfer table illustrated in FIG. 9(C) as illustrated in FIG. 10(A). The transfer table setting unit 23 stores the updated transfer table in the transfer table storage unit 24. Communication restoration of the ONU 10-1 is confirmed in the transition destination OLT 20 (step S116).

Thereafter, if there is no particular problem, the operator removes components other than the core line after switching of the transition assistance device 27-1 (step S117).

With the processing from step S110 to step S117, the ONU 10-1 can transmit and receive data to and from the relay device 30. Specific examples will be described. Downlink data transmission from the relay device 30 to the ONU 10-1 will be described. It is assumed that the data addressed to the ONU 10-1 is transferred from the relay device 30 to the transition destination OLT 20 after the processing of step S116. In this case, the transition destination OLT 20 receives, at the relay port 221, the data addressed to the ONU 10-1 transmitted from the relay device 30. On the basis of the received data and the relay port 221 receiving the data, the transfer control unit 26 refers to the transfer table stored in the transfer table storage unit 24 and determines the transfer destination of the data. In the transfer table illustrated in FIG. 10(A), in a case where the destination is the ONU 10-1 and the reception port is the relay port 221, the transfer destination is set to the ONU connection port 211-1. Thus, the transfer control unit 26 transfers the received data to the ONU connection port 211-1 in the subscriber side transfer unit 21-1. The ONU connection port 211-1 is connected to the ONU 10-1 via the transition assistance device 27-1 via an optical fiber. For that reason, the data output from the ONU connection port 211-1 is input to the ONU 10-1 via the transition assistance device 27-1. As described above, the downlink data transmission from the relay device 30 to the ONU 10-1 becomes possible.

Next, the uplink data transmission from the ONU 10-1 to the relay device 30 will be described. It is assumed that data addressed to the relay device 30 is transmitted from the ONU 10-1 to the transition assistance device 27-1. The transition assistance device 27-1 is connected to the ONU connection port 211-1 of the transition destination OLT 20 via an optical fiber. For that reason, the data transmitted from the ONU 10-1 is received at the ONU connection port 211-1 of the transition destination OLT 20 via the transition assistance device 27-1. The data received at the ONU connection port 211-1 is input to the transfer control unit 26. On the basis of the received data and the ONU connection port 211-1 receiving the data, the transfer control unit 26 refers to the transfer table and determines the transfer destination of the data. In the transfer table illustrated in FIG. 10(A), in a case where the destination is the relay device 30 and the reception port is the ONU connection port 211-1, the transfer destination is set to the relay port 221. Thus, the transfer control unit 26 transfers the received data to the relay port 221. The relay port 221 is connected to the relay device 30 via an optical fiber. For that reason, the data output from the relay port 221 is input to the relay device 30. As described above, the uplink data transmission from the ONU 10-1 to the relay device 30 becomes possible.

As described above, communication between the ONU 10-1 and the relay device 30 can be performed without passing through the transition source OLT 15. On the other hand, the ONUs 10 other than the ONU 10-1 perform communication with the relay device 30 via the transition source OLT 15 because the processing from step S110 to step S117 is not executed.

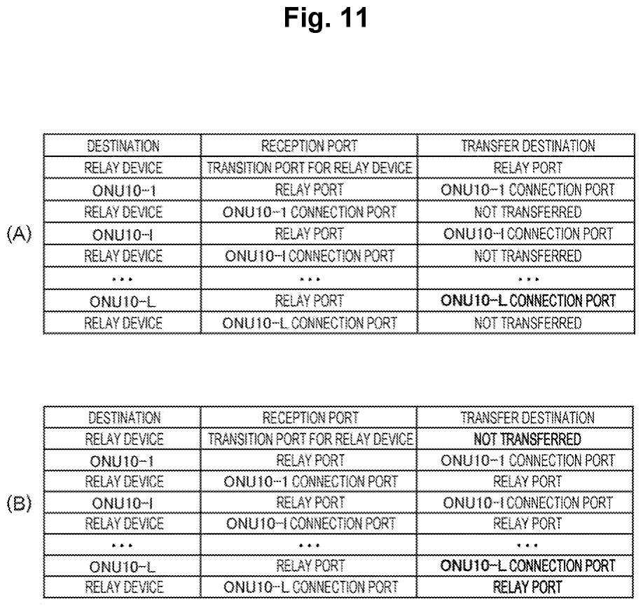

The operator executes the processing from step S110 to step S117 as many as the number of ONUs 10 connected to the transition assistance device 27. For example, after completing the processing from step S110 to step S117 for one ONU 10 connected to the transition assistance device 27, the operator executes the processing from step S110 to step S117 for the next ONU 10. As a result, the transfer table setting unit 23 updates the information of the transfer table for each ONU 10. For example, the transfer table setting unit 23 updates the information of the transfer table in the order of FIGS. 10(B), 10(C), 11(A), and 11(B).

At the time of setting of the transfer table related to the ONU 10-L for which setting is to be performed last, the operator operates the external device to transmit, to the transition destination OLT 20, a command for causing Content 6 described below to be set in the transfer table in addition to Content 5.

(Content 6) A content for causing a destination “relay device 30”, a reception port “relay device transfer port 222”, and a transfer destination “not transferred” to be set.

Content 6 is a content for causing settings to be set so that in a case where the data whose destination is the relay device 30 is received at the relay device transfer port 222 of the transition destination OLT 20, the received data is not transferred. This is because, in a case where all the ONUs 10 are connected to the transition destination OLT 20 and the setting of communication with the relay device 30 is completed, there is no need to transfer the data to the transition source OLT 15.

With the above processing, all the ONUs 10 connected to the transition assistance device 27 can communicate with the relay device 30 without passing through the transition source OLT 15. Thereafter, the operator removes the transition source OLT 15 and unnecessary wiring (step S118).

According to the optical access system 1 configured as described above, it is possible to suppress an influence of communication interruption in transition of a device. Specifically, in the optical access system 1, the transition assistance device 27 is connected for each ONU 10, and one transition assistance device 27 is connected to one port of the transition source OLT 15, the ONU connection port 211 in one subscriber side transfer unit 21 of the transition destination OLT 20, and one or more ONUs 10. The transition assistance device 27 connects the ONU 10 and the transition destination OLT 20 to each other via an optical fiber at the start of transition, and cuts the optical fiber connecting the ONU 10 and the transition destination OLT 20 to each other after the ONU 10 is connected to the transition destination OLT 20 via the transition assistance device 27. Thereafter, the transition assistance device 27 moves the movable member 272 to connect the ONU 10 and the transition destination OLT 20 to each other by an optical fiber. As a result, at the time of switching of one ONU 10, only the transition assistance device 27 connected to the ONU 10 is controlled, and thus switching of the other ONUS 10 is not affected. That is, the other ONUS 10 can continue communication with the relay device 30 via the transition source OLT 15 and the transition destination OLT 20. As described above, by using the transition assistance device 27, it is possible to continue user's communication even at the time of switching of the other ONUS 10. Then, after the switching of all the ONUS 10 is ended, the data transfer to the transition source OLT 15 is stopped, and processing is performed in the transition destination OLT 20, whereby the user's communication interruption time can be shortened. For that reason, it is possible to suppress the influence of communication interruption.

Further, in the optical access system 1, the transition destination OLT 20 includes the relay device transfer port 222 that transfers the data transferred from the relay device 30 to return the data to the transition source OLT 15. At the time of transition of the OLT, after the connection with the relay device 30 is switched to the transition destination OLT 20, the transition destination OLT 20 transfers the data transferred from the relay device 30 to the transition source OLT 15 via the relay device transfer port 222. As a result, while the connection of one ONU 10 is switched from the transition source OLT 15 to the transition destination OLT 20, communication of the other ONUs 10 can be continued via the transition source OLT 15 and the transition destination OLT 20. Then, after the switching of all the ONUs 10 is ended, the data transfer to the transition source OLT 15 is stopped, and processing is performed in the transition destination OLT 20, whereby the user's communication interruption time can be shortened. For that reason, it is possible to suppress the influence of communication interruption.

In the transition destination OLT 20, since the switching is performed individually for the relay device 30 and each ONU 10, even in a case where a problem occurs in the setting of the transition destination OLT 20, or the like, the switch-back can be easily performed.

The communication interruption seen from the user terminal 40 intermittently occurs at the time of connection switching of the relay device 30, connection switching of the ONU 10, and path switching of the optical SW 214, but it is possible to reduce the number of steps between one communication interruption and completion confirmation as in the conventional method, and it is possible to suppress the communication interruption caused by waiting for completion of a step related to another user.

In the conventional method, whether or not the transfer setting is successfully copied and converted, and whether or not the port of the connection switching destination is correctly connected, are confirmed after the connection switching or the setting change is performed, but whether or not they are correctly performed so that the user's communication finally is restored cannot be confirmed until both the relay device side connection line and the ONU side connection line are switched. If the communication is not restored, there has been a problem that a switch-back step is complicated, it takes time for cause investigation, and the communication interruption increases considerably.

On the other hand, in the optical access system 1, whether or not the transfer setting is successfully copied and converted, and whether or not the port of the connection switching destination is correctly connected can be confirmed in a form of user's communication restoration for each piece of work. As a result, a switch-back determination can be made in each step, and it is possible to suppress an increase in the communication interruption time due to the switch-back work.

Since connection work between the transition destination OLT 20 and the relay device 30 and connection work between the transition destination OLT 20 and the ONU 10 are physical configurations, local work is required; however, update of the transfer table and switching of the optical SW 214 can be performed collectively and remotely, and its step can be divided. For that reason, appropriate technicians and time can be allocated to each step.

In the optical access system 1 in the present embodiment, two connection procedures after connection disconnection are required at each of connection changes in FIGS. 4(C) and 5(A). In a case where transition is performed to the transition destination OLT 20 and then transition to another OLT is further performed, connection between the transition source OLT 15 and the transition destination OLT 20 in FIG. 4(D) can be performed without communication interruption, and a connection procedure in the next transition can be simplified.

The transition destination OLT 20 may perform switching of the ONUs 10 in any order.

The cutting unit 278 may be a manual fiber cutter that manually cuts the optical fiber or a fiber cutter that semi-automatically cuts the optical fiber.

The cutting unit 278 may be included in the fixed member 271.

Some functions (for example, processing of updating the transfer table by the transfer table setting unit 23) of the transition destination OLT 20 and some functions (for example, cutting processing by the cutting unit 278, movement control by the movement control unit 279, and fusion processing by the fusion mechanisms 275 and 276) of the transition assistance device 27 in the embodiment described above may be implemented by a computer. In that case, a program for implementing these functions may be recorded in a computer-readable recording medium, and the program recorded in the recording medium may be read and executed by a computer system to implement the functions. Note that the “computer system” mentioned herein includes an OS and hardware such as a peripheral device. Also, the “computer-readable recording medium” refers to a portable medium such as a flexible disk, a magneto-optical disk, a ROM, or a CD-ROM, or a storage device such as a hard disk included in the computer system. Further, the “computer-readable recording medium” may include a medium that dynamically holds the program for a short time, such as a communication line in a case where the program is transmitted via a network such as the Internet or a communication line such as a telephone line, and a medium that holds the program for a certain period of time, such as a volatile memory inside the computer system serving as a server or a client in that case. Also, the above program may be for implementing some of the functions described above, may be formed with a combination of the functions described above and a program already recorded in the computer system, or may be formed with a programmable logic device such as an FPGA.

Although the embodiment of the present invention has been described in detail with reference to the drawings so far, the specific configuration is not limited to this embodiment, and includes a design and the like without departing from the scope of the present invention.

### INDUSTRIAL APPLICABILITY

The present invention can be applied to a technology associated with transition of an optical communication device.

### REFERENCE SIGNS LIST

10-1 to 10-L ONU

15 transition source OLT

20 transition destination OLT

30 relay device

21-1 to 21-N subscriber side transfer unit

22 relay device side transfer unit

23 transfer table setting unit

24 transfer table storage unit

27 transition assistance device

26 transfer control unit

211 ONU connection port

221 relay port

222 relay device transfer port

278 cutting unit

1. A transition assistance device that assists device replacement in an optical access system including: a transition source subscriber line terminal station device before device replacement, the transition source subscriber line terminal station device communicating with a higher-level device and one or more subscriber line terminal devices; and a transition destination subscriber line terminal station device that is a device replacement destination,
the transition assistance device comprising:
a first member, and a second member that is movable, wherein
the first member includes a first port for connecting to the transition source subscriber line terminal station device, and a second port for connecting to the transition destination subscriber line terminal station device,
the second member includes a third port for connecting to the one or more subscriber line terminal devices connected to the transition source subscriber line terminal station device, and
at a start of the device replacement, the transition assistance device is not connected to the transition destination subscriber line terminal station device via the second port, and the first port and the third port are connected to each other via a connection line;
a cutting unit that cuts the connection line connecting the first port and the third port to each other after the transition assistance device is connected to the transition destination subscriber line terminal station device via the second port;
a movement control unit that moves the second member after the connection line is cut by the cutting unit; and
a connection unit that connects the second port and the third port to each other with connection lines after movement of the second member.

2. The transition assistance device according to claim 1, wherein the connection unit connects the second port and the third port to each other with the connection lines by fusion.

3. The transition assistance device according to claim 1, wherein at least the first port of the first member, the cutting unit, and the movement control unit are removable.

4. A transition method performed by a transition assistance device that assists device replacement in an optical access system including: a transition source subscriber line terminal station device before device replacement, the transition source subscriber line terminal station device communicating with a higher-level device and one or more subscriber line terminal devices; and a transition destination subscriber line terminal station device that is a device replacement destination, wherein
the transition assistance device includes a first member, and a second member that is movable,
the first member includes a first port for connecting to the transition source subscriber line terminal station device, and a second port for connecting to the transition destination subscriber line terminal station device,
the second member includes a third port for connecting to the one or more subscriber line terminal devices connected to the transition source subscriber line terminal station device, and
at a start of the device replacement, the transition assistance device is not connected to the transition destination subscriber line terminal station device via the second port, and the first port and the third port are connected to each other via a connection line, the transition method comprising:
cutting the connection line connecting the first port and the third port to each other after the transition assistance device is connected to the transition destination subscriber line terminal station device via the second port;
moving the second member after the connection line is cut; and
connecting the second port and the third port to each other with connection lines after movement of the second member.

5. An optical access system including: a transition source subscriber line terminal station device before device replacement, the transition source subscriber line terminal station device communicating with a higher-level device and one or more subscriber line terminal devices; and a transition destination subscriber line terminal station device that is a device replacement destination,
the optical access system comprising
a transition assistance device that assists device replacement between the transition destination subscriber line terminal station device and the one or more subscriber line terminal devices,
wherein
the transition assistance device includes:
a first member, and a second member that is movable, wherein
the first member includes a first port for connecting to the transition source subscriber line terminal station device, and a second port for connecting to the transition destination subscriber line terminal station device,
the second member includes a third port for connecting to the one or more subscriber line terminal devices connected to the transition source subscriber line terminal station device, and
at a start of the device replacement, the transition assistance device is not connected to the transition destination subscriber line terminal station device via the second port, and the first port and the third port are connected to each other via a connection line;
a cutting unit that cuts the connection line connecting the first port and the third port to each other after the transition assistance device is connected to the transition destination subscriber line terminal station device via the second port;
a movement control unit that moves the second member after the connection line is cut by the cutting unit; and
a connection unit that connects the second port and the third port to each other with connection lines after movement of the second member, and
the transition destination subscriber line terminal station device includes:
a higher-level device side transition unit including a higher-level port for connecting to the higher-level device and a first transition port that transfers data transferred from the higher-level device to the transition source subscriber line terminal station device;
a transfer table setting unit that changes a setting of a transfer table in which a port at which data is received, a destination of the data, and a port of a transfer destination of the data are associated with each other; and
a transfer control unit that performs data transfer to the transition source subscriber line terminal station device via at least the first transition port in accordance with the transfer table.

6. The optical access system according to claim 5, wherein, at the start of the device replacement, the transfer table setting unit changes the setting of the transfer table such that data addressed to the subscriber line terminal devices received at the higher-level port is transferred to the first transition port, and data addressed to the higher-level device received at the first transition port is transferred to the higher-level port.

7. The optical access system according to claim 5, wherein
a plurality of the transition assistance devices is included, and
one or more subscriber line terminal devices are respectively connected to the transition assistance devices.
